(19) United States
(12) Patent Application Publication
(10) Pub. No.: US 2024/0385388 A1
(43) Pub. Date: Nov. 21, 2024

(54) Optical Devices and Methods of Manufacture

(71) Applicant: Taiwan Semiconductor Manufacturing Co., Ltd., Hsinchu (TW)

(72) Inventors: Chen-Hua Yu, Hsinchu (TW); Szu-Wei Lu, Hsinchu (TW); Tsung-Fu Tsai, Changhua City (TW); Chao-Jen Wang, Hsinchu City (TW)

(21) Appl. No.: 18/319,854

(22) Filed: May 18, 2023

(51) Int. Cl. G02B 6/38; G02B 6/40

(52) U.S. Cl. CPC G02B 6/3861; G02B 6/403

(57) ABSTRACT

Devices and methods of manufacture and use of a fiber bundle is presented. In embodiments the fiber bundle comprises a substrate material and optical fiber openings that extend from a first side of the substrate material to a second side of the substrate material, wherein the optical fiber openings at the first side of the substrate material are shifted either horizontally or vertically from the second side of the substrate material.

### BACKGROUND

Electrical signaling and processing are one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Improvements in each of these long-range optical components and short-range electrical components are desired.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1C illustrate a fiber bundle, in accordance with some embodiments.

FIGS. 2A-2B illustrate optical fibers and a ferrule, in accordance with some embodiments.

FIG. 3 illustrates placement of the fiber bundle on the optical fibers, in accordance with some embodiments.

FIG. 4 illustrates placement of a fiber array unit on the optical fibers, in accordance with some embodiments.

FIGS. 5A-5D illustrate a fiber bundle with dispensing regions, in accordance with some embodiments.

FIGS. 6A-6C illustrate a fiber bundle with multi-dimensional shifts, in accordance with some embodiments.

FIGS. 7A-8B illustrate a multiple part fiber bundle, in accordance with some embodiments.

FIGS. 9A-9H illustrate a single unit fiber bundle with multiple dimensional shifts, in accordance with some embodiments.

FIGS. 10A-10E illustrate use of the fiber bundle with ribbon fibers, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to a particular embodiment in which a fiber bundle 100 is utilized to help provide support and relieve stress to optical fibers 201. The embodiments described herein, however, are intended to be illustrative and are not intended to be limiting. Rather, the ideas presented may be implemented in a wide variety of embodiments, and all such embodiments are fully intended to be included within the scope of the disclosure.

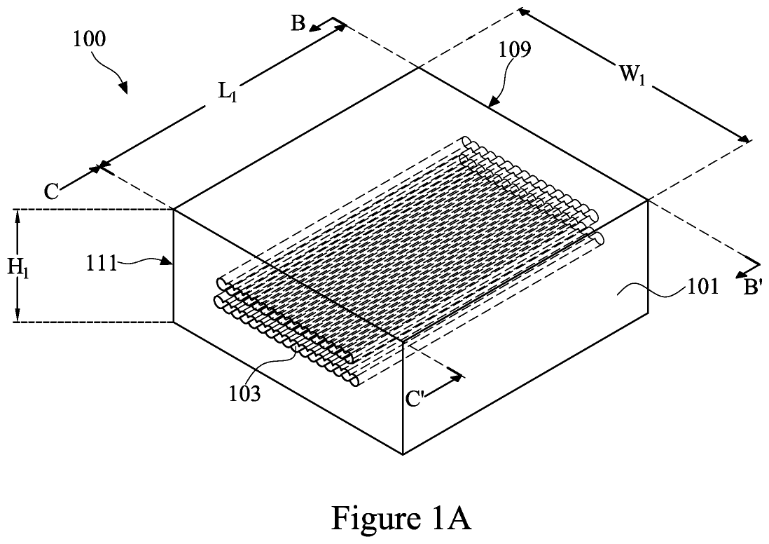

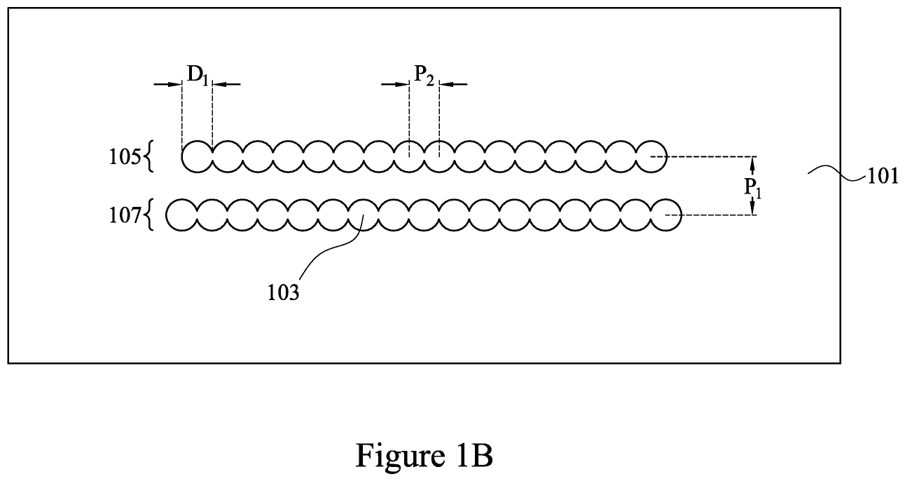

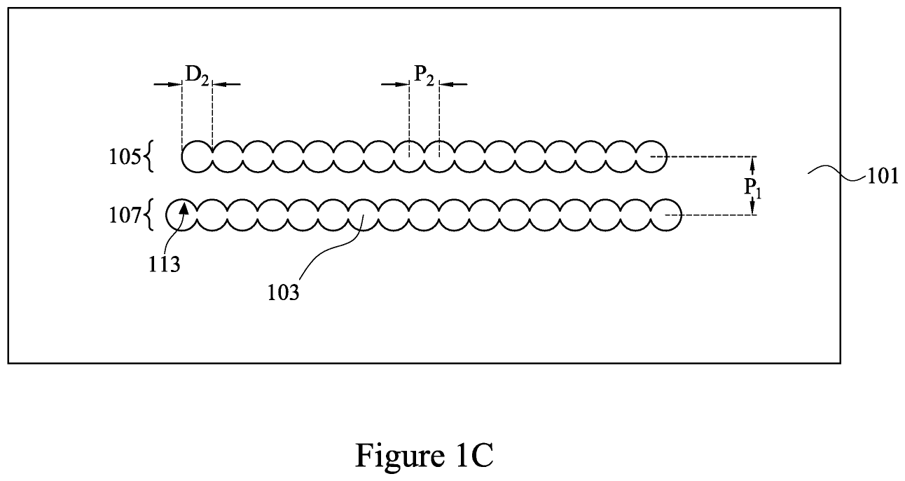

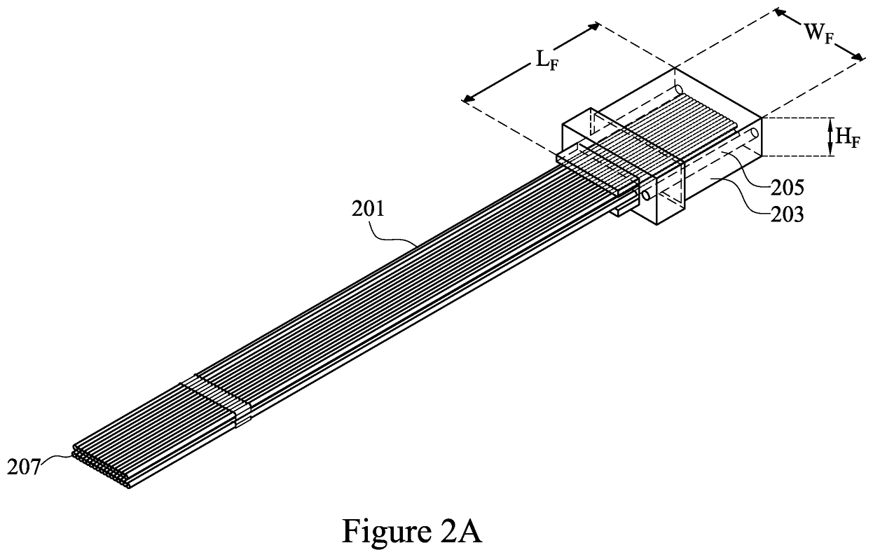

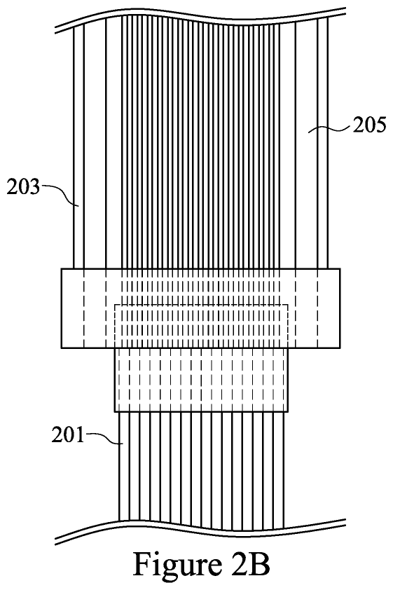

With reference now to FIG. 1A, this figure illustrates a fiber bundle 100 that will be used to provide support and help relieve stress along a plurality of optical fibers 201 (not illustrated in FIG. 1A but illustrated and discussed further below with respect to FIG. 2A). In an embodiment the fiber bundle 100 may comprise a substrate 101 with openings 103 that extend from a first side of the substrate 101 to a second side of the substrate 101.

In an embodiment the substrate 101 comprises a support material that may also optionally function as additional cladding material for the optical fibers 201 that will be placed through the substrate 101. In a particular embodiment the support material may be a material such as a polymer, ceramics, metal, combinations of these, or the like. However, any suitable material may be utilized.

Additionally, the substrate 101 may be sized in order to help provide support and relieve stress to the optical fibers 201 that will be placed through the substrate 101. As such, while the dimensions of the substrate 101 may be dependent at least in part on the size and number of optical fibers 201, in some embodiments the substrate 101 may have a first width W₁ of between about 3 mm and about 10 mm, such as about 7 mm, and may have a first length L₁ of between about 4 mm and about 15 mm, such as about 7.5 mm. Additionally, the substrate 101 may have a first height H₁ of between about 1.5 mm and about 4 mm, such as about 3 mm. However, any suitable dimensions may be utilized.

In an embodiment the substrate 101 may be manufactured using a three-dimensional printing technique. In such a manufacturing process, small, individual layers of the substrate 101 may be sequentially deposited on top of each other in order to form the desired structure as the material is built up. However, any suitable manufacturing process may be utilized.

The openings 103 are formed to extend through the substrate 101 from a first side 109 of the substrate 101 to a second side 111 of the substrate 101. In an embodiment the openings 103 are used to control and support the optical fibers 201 as the optical fibers 201 extend through the substrate 101. In some embodiments the openings 103 have changing dimensions such as size or pitch as the openings 103 extend from the first side 109 of the substrate 101 to the second side 111 of the substrate.

To help illustrate this change in dimensions, FIG. 1B illustrates a cross-sectional view of the first side 109 of the substrate 101 and the openings 103 along line B-B′ in FIG. 1A. In this view the openings 103 can be seen as the openings 103 enter the substrate 101. In an embodiment the openings 103 may be arranged in two separate rows such as a first row 105 and a second row 107, wherein the first row 105 is separated from the second row 107 by material of the substrate 101. The first row 105 may be separated from the second row 107 by a first pitch P₁ of between about 250 μm and about 500 μm, such as about 500 μm. However, any suitable number of different rows and any suitable pitch may be utilized.

Additionally, in this embodiment the openings 103 on the first side 109 of the substrate 101 may be formed to have a relatively wider first diameter D₁ of between about 250 μm and about 400 μm, such as about 300 μm. Additionally, the openings 103 within each row (within either of the first row 105 or the second row 107) may have a second pitch P₂ of between about 250 μm and about 300 μm, such as about 250 μm. However, any suitable dimensions may be utilized.

FIGS. 1B-1C additionally illustrate a dummy opening 113 that also extends through the substrate 101. In an embodiment the dummy opening 113 is another opening that is sized similarly to the remainder of the openings 103 but into which a dummy fiber (e.g., a non-functioning optical fiber that does not transmit signals) is placed. However, in other embodiments the dummy opening 113 may be omitted.

Looking at the other side of the fiber bundle 100, FIG. 1C illustrates a cross-sectional view of the substrate 101 and the openings 103 at the second side 111 of the fiber bundle 100 along line C-C′ in FIG. 1A on an opposite side of the substrate 101 from the view in FIG. 1B. In this view the openings 103 can be seen as the openings 103 exit the substrate 101. In an embodiment the openings 103 may remain in the two separate rows, wherein each row is separated by material of the substrate 101. The rows in this embodiment may remain separated by the first pitch P₁. However, any suitable number of different rows and any suitable pitch may be utilized.

In an embodiment the openings 103 on this side of the substrate 101 may be placed and sized in order to effectuate a horizontal shift in the openings 103 from the first side 109 to the second side 111 of the substrate 101. For example, in order to have the horizontal shift within each row (e.g., within the bottom second row 107 or within the top first row 105) the openings on the second side 111 of the substrate 101 have the second pitch P₂ and may have a second diameter D₂ that is less than or narrower than the first diameter D₁ and which is sized to help hold and support the optical fibers 201 once the optical fibers 201 have been placed. As such, while the precise size of the second diameter D₂ is dependent at least in part on the size of the optical fibers 201, in an embodiment in which the optical fibers 201 are 250 μm, the second diameter D₂ may be between about 250 μm and about 400 μm, such as about 265 μm. However, any suitable dimensions may be utilized.

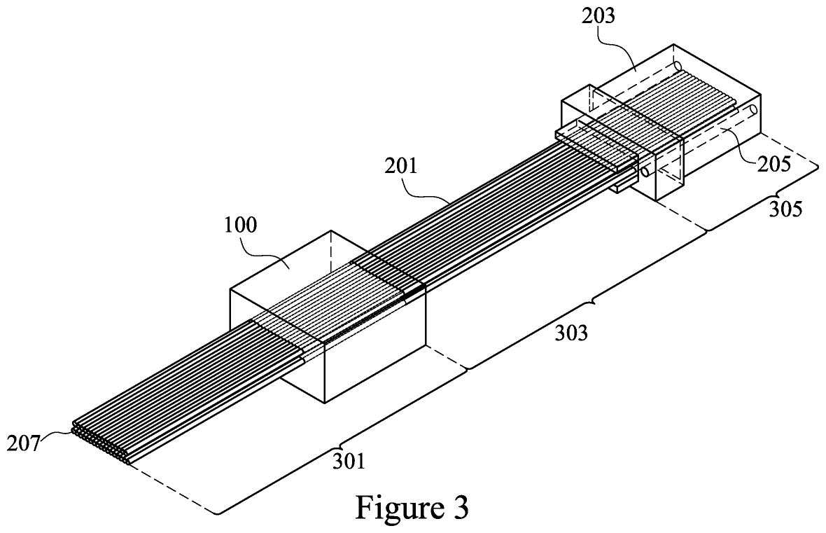

FIGS. 2A and 2B illustrate the optical fibers 201 that will be inserted into the fiber bundle 100 (see FIG. 3) along with a ferrule 203 attached to the optical fibers 201, with FIG. 2B being a top down view of the ferrule 203 of FIG. 2A. In an embodiment each of the optical fibers 201 comprises a core material such as glass surrounded by one or more cladding materials. Optionally, a surrounding cover material may be used to surround the outer cladding material in order to provide additional protection. Collectively, each of the individual optical fibers 201, either with or without the cover material, may have a diameter of between about 125 μm and about 265 μm, such as about 250 μm and may have a length outside of the ferrule 203 of between about 10 mm and about 50 mm, such as about 33.7 mm. Additionally, the optical fibers 201 may have a portion that is inserted into the ferrule 203 that has a diameter of between about 124 μm and about 126 μm, such as about 125 μm. However, any suitable dimensions may be utilized.

Optionally, in some embodiments a dummy optical fiber 207 may be used along with the optical fibers 201. In an embodiment the dummy optical fiber 207 may be similar to the optical fibers 201, but which is non-functional and which is not used to carry optical signals or power. However, in other embodiments the dummy optical fiber 207 may not be used.

The ferrule 203 may be used to receive the plurality of optical fibers 201, align the optical fibers 201, and connect the optical fibers 201 to another device (not separately illustrated in FIG. 2A). In a particular embodiment the ferrule 203 may be a mechanical transfer (MT) ferrule and the like made of a material that can be used to protect, support and align the individual optical fibers 201. However, any suitable materials may be utilized.

In an embodiment the ferrule 203 may be formed to have a ferrule length LF of about 8.05 mm and a ferrule width W_{F} of-about 6.4 mm. Additionally, the ferrule 203 may have a ferrule height H_{F} of about 2.45 mm. However, any suitable dimensions may be utilized.

The ferrule 203 may include optical fiber openings that extend through the ferrule 203. In an embodiment the optical fiber openings may have a same configuration similar to the fiber bundle 100. In other embodiments the optical fiber openings may be aligned in a single row, such that there is no staggered orientation. Any suitable configuration may be utilized.

The ferrule 203 may additionally comprise one or more guide holes 205. The guide holes 205 are utilized along with guide pins (not separately illustrated) in order to help align and secure the ferrule 203 with other devices. However, any suitable guidance mechanisms may be utilized.

The optical fibers 201 may be inserted into openings located within the ferrule 203. Once inserted a glue material, such as an epoxy, silicone, a photocurable elastic polymer, combinations of these, or the like, may be injected or otherwise placed into the openings within the ferrule 203 in order to secure the optical fibers 201 within the ferrule 203. Additionally, a curing process such as a light cure, a heat cure, or the like, may be utilized to harden the glue material, and the optical fibers 201 may be polished and cleaned in order to prepare the optical fibers 201 within the ferrule 203 for optical connection to other devices.

FIG. 3 illustrates that, once the optical fibers 201 have been have inserted and glued into the ferrule 203, the fiber bundle 100 may be placed onto the optical fibers 201. In an embodiment the fiber bundle 100 may be placed by inserting the optical fibers 201 through the openings 103 in the first side 109 of the fiber bundle 100, such as by inserting the optical fibers 201 into the openings 103 illustrated in FIG. 1B (e.g., the side on which the openings 103 have a larger diameter). The placement may be performed manually or else using an automated process.

Optionally, in the embodiments which utilize the dummy opening 113, the dummy optical fiber 207 may be inserted simultaneously or sequentially with the other optical fibers 201. In an embodiment the dummy optical fiber 207 may be inserted either manually or using an automated process. However, any suitable process or processes may be utilized.

Once the optical fibers 201 have been placed into the fiber bundle 100, the optical fibers 201 may optionally be adhered to the fiber bundle 100 using a glue material (not separately illustrated). In an embodiment the glue material may be an epoxy adhesion material dispensed by injecting the glue material into the openings 103 while the optical fibers 201 are located within the openings 103. However, any suitable material and any suitable method of placement may be utilized.

In some embodiments in which the ferrule 203 aligns the optical fibers 201 in a double row, aligned configuration, but in which the fiber bundle 100 utilizes a staggered configuration for the openings 103, the fiber bundle 100 and the ferrule 203 separate the optical fibers 201 into a first region 301, a second region 303, and a third region 305. In an embodiment the first region 301 may be a staggered region in which the optical fibers 201 are in a staggered configuration because the fiber bundle 100 constrains the optical fibers 201 into the staggered configuration. Additionally, the third region 305 may be an aligned region because the ferrule 203 constrains the optical fibers 201 into the aligned, double row configuration. Between the first region 301 and the third region 305, the second region 303 serves as a transition region, wherein the optical fibers 201 transition from the staggered configuration to the aligned configuration. Of course, any suitable configurations may be utilized.

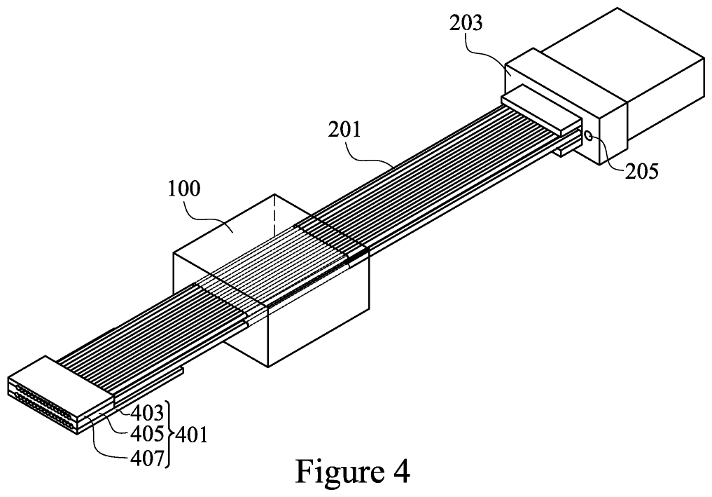

FIG. 4 illustrates placement of a fiber array unit 401 onto an end of the optical fibers 201 opposite the fiber bundle 100 from the ferrule 203. In an embodiment the fiber array unit 401 comprises a fiber array substrate 403, a first lid 405, and a second lid 407. In an embodiment the fiber array substrate 403 comprises a substrate material into which a plurality of grooves are formed for alignment of some of the individual optical fibers 201 (and, optionally, the dummy optical fiber 207). The optical fibers 201 are placed into the individual grooves, and the first lid 405 is placed on top of the optical fibers 201 in order to constrain and control the optical fibers 201. Additionally, if a staggered configuration is desired, the first lid 405 may also have additional grooves in order to place additional optical fibers 201 over the first lid 405, and the second lid 407 is placed in order to constrain a second row of the optical fibers 201. However, any suitable structure for the fiber array unit 401 may be utilized.

Optionally at this point in the process, if desired, once the fiber array unit 401 has been placed around the optical fibers 201, the optical fibers 201 may be cleaved. In a particular embodiment the optical fibers 201 may be cleaving using a process such as laser cleaving. However, any suitable process may be utilized to cleave the optical fibers 201.

By utilizing the fiber bundle 100 between the fiber array unit 401 and the ferrule 203, the fiber bundle 100 can help to confine the orientation of the optical fibers 201 and provides additional support for the optical fibers 201. Additionally, during subsequent operations, such as the plugging in or unplugging of the ferrule 203, the fiber bundle 100 helps to relax stress on the optical fibers 201. As such, the fiber bundle 100 can help to extend the overall lifespan of the optical fibers 201.

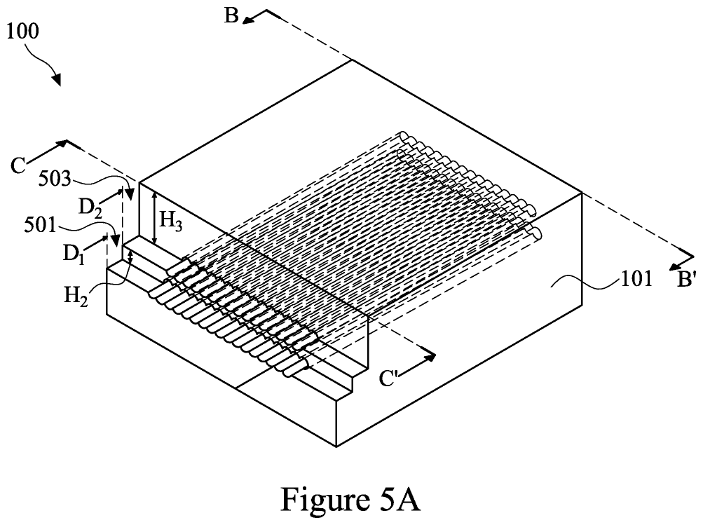

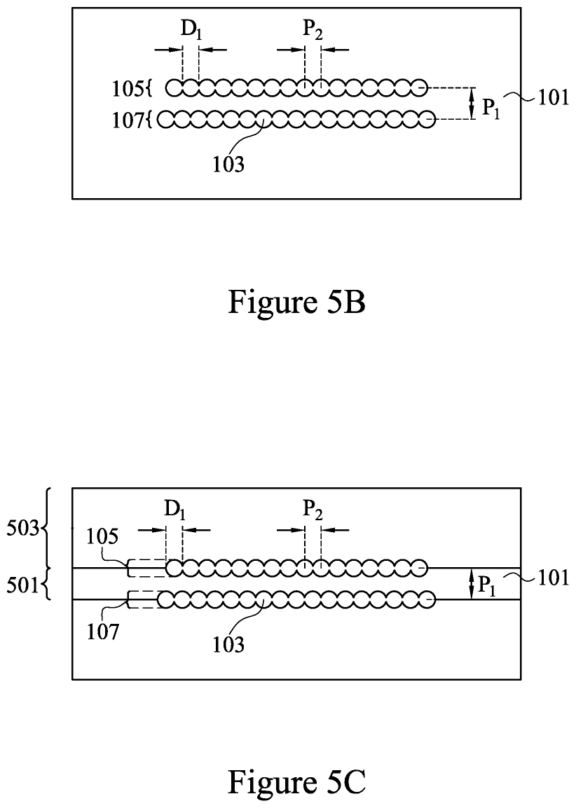

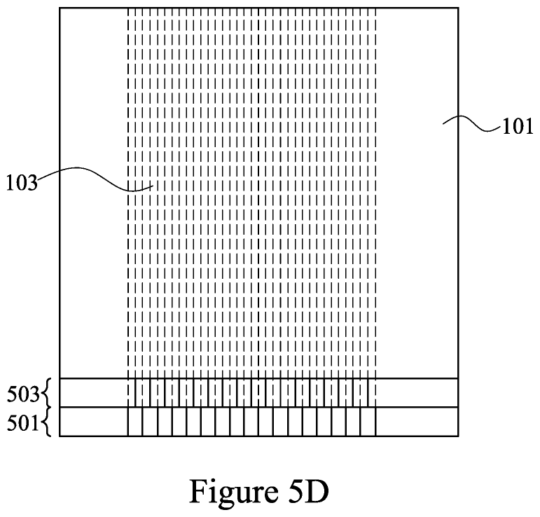

FIG. 5A illustrates another embodiment of the fiber bundle 100 that may be used in order to help dispense an adhesive. In this embodiment, the fiber bundle 100 is not formed as a cuboid shape. Rather, it is formed in a stair step shape along the second side 111 such that a first dispensing region 501 is located to assist in the dispensing of the adhesive along the second row 107, and a second dispensing region 503 is located to assist in the dispensing of the adhesive along the first row 105.

In an embodiment the first dispensing region 501 may have an offset distance D₁ (e.g., offset from a side of the edge of the fiber bundle 100) of between about 0.5 mm and about 1 mm. Similarly, the first dispensing region 501 may have a second height H₂ of between about 0.5 mm and about 1 mm. However, any suitable dimensions may be utilized.

Additionally the second dispensing region 503 may have a second offset distance D₂ (e.g., offset from a side of the edge of the first dispensing region 501) of between about 1 mm and about 2 mm. Similarly, the second dispensing region 503 may have a third height H₃ of between about 0.5 mm and about 1 mm. However, any suitable dimensions may be utilized.

FIGS. 5B-5D illustrate various cross-sectional and top down views of the fiber bundle 100 with the first dispensing region 501 and the second dispensing region 503. In particular, FIG. 5B illustrates a view taken along line B-B′ in FIG. 5A, while FIG. 5D illustrates a top down view of the fiber bundle 100 with the first dispensing region 501 and the second dispensing region 503. FIG. 5C illustrates a view taken along line C-C′ in FIG. 5A, and shows the first dispensing region 501 and the second dispensing region 503 in cross-section.

By forming the fiber bundle 100 with the first dispensing region 501 and the second dispensing region 503, the dispensing of the adhesive used to hold the optical fibers 201 to the fiber bundle 100 can be made easier. In particular, by providing the ledges of the first dispensing region 501 and the second dispensing region 503, additional surface area between the subsequently dispensed glue and the fiber bundle 100 is formed. This allows for a greater adherence between the optical fibers 201 and the fiber bundle 100.

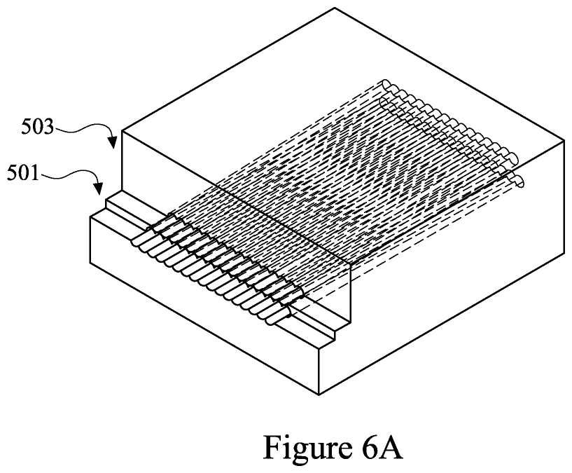

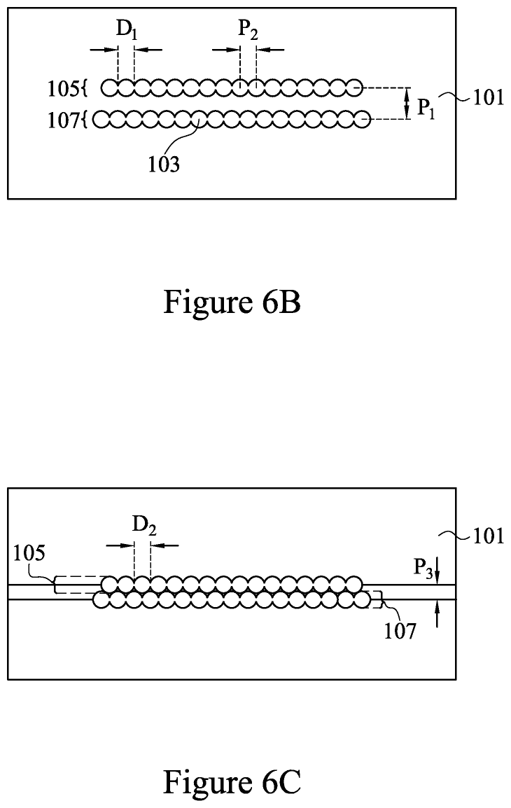

FIGS. 6A-6C illustrate yet another embodiment which utilizes the first dispensing region 501 and the second dispensing region 503, but in which there is not only a horizontal shift in the openings 103 (as described above with respect to FIGS. 1A-1C) but there is also a vertical shift in the openings 103 from the first side 109 of the fiber bundle 100 to the second side 111 of the fiber bundle 100.

In this embodiment the openings 103 entering the fiber bundle 100 from the first side 109 (as seen in FIG. 6B) may be similar to the openings 103 as illustrated in FIG. 1B above. For example, the openings 103 may have the first diameter D_{1,} may be separated from each other within a single row by the second pitch P_{2,} and the rows may be separated from each other by the first pitch P_{1.} However, any suitable dimensions may be utilized.

However, as the openings 103 extend through the fiber bundle 100 from the first side 109 to the second side 111 of the substrate 101, the openings 103 have a vertical shift as well as the horizontal shift already described. In particular, in this embodiment the openings 103 in the first row 105 and the second rows 107 move closer together as the openings 103 extend through the fiber bundle 100, such that the openings 103 within the first row 105 and the second row 107 have a third pitch P₃ that is less than the second diameter D₂, such as a third pitch P₃ of between about 215 μm and about 500 μm, such as about 215 μm. As such, the openings 103 within the first row 105 may extend at least partially in to the second row 107. However, any suitable third pitch P₃ may be utilized.

By forming the fiber bundle as described in FIGS. 6A-6C. greater options are available to help constrain and protect the optical fibers 201. In particular, by using more than the single, horizontal shift as described above with respect to FIGS. 1A-5D, more shifts may be used, allowing the various designs to be tailored to a particular process or use.

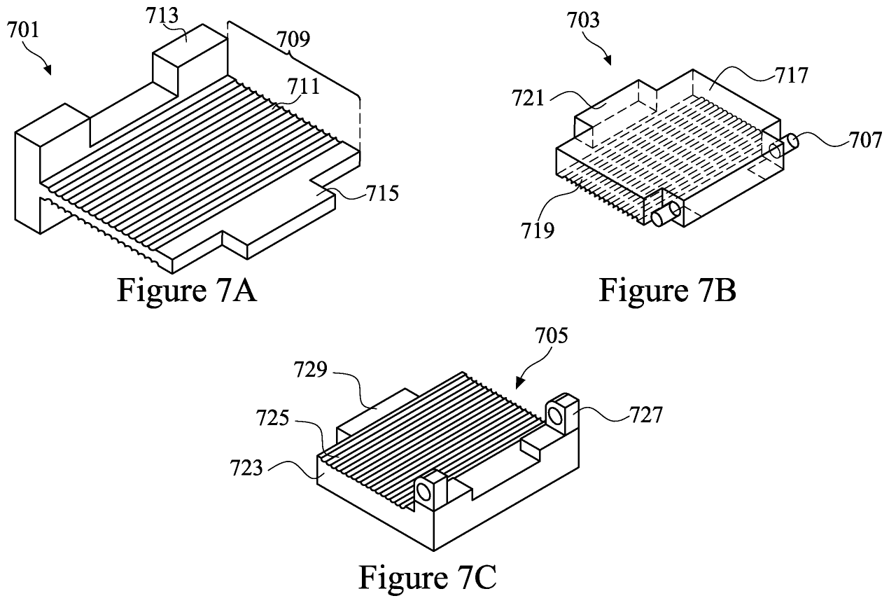

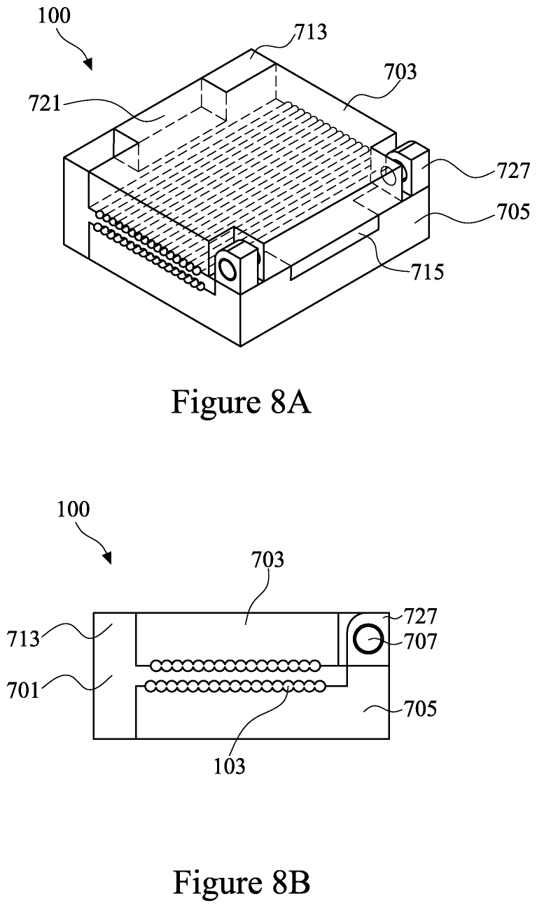

FIGS. 7A-7C illustrate another embodiment in which the fiber bundle 100, instead of being manufactured as a single unit, is instead manufactured in multiple parts which are subsequently put together. In a particular embodiment the fiber bundle 100 is manufactured with a first part 701 (illustrated in FIG. 7A), a second part 703 (illustrated in FIG. 7B), and a third part 705 (illustrated in FIG. 7C). The first part 701 may have a central portion 709 which comprises first indentations 711 on both sides of the central portion 709. The first indentations 711, when the central portion 709 is coupled with the second part 703 and the third part 705, will form the openings 103 (as illustrated in FIGS. 8A-8B) through which the optical fibers 201 are subsequently placed.

The first part 701 additionally comprises a first connecting portion 713 and a second connecting portion 715 that work in conjunction with the second part 703 and the third part 705 to align and connect the different parts together. In an embodiment the first connecting portion 713 has an indentation which receives connecting parts of the second part 703 and the third part 705, while the second connecting portion 715 comprises an extension which will be received by the second part 703 and the third part 705. However, any suitable connecting portions may be utilized.

FIG. 7B illustrates the second part 703. In an embodiment the second part 703 comprises a first lid portion 717 which comprises second indentations 719 which, when the second part 703 is coupled with the first part 701, will form the openings 103 with the first indentations 711. Additionally, the second part 703 further comprises a first hinge portion 707 which can be input into the third part 705 and a third connecting portion 721 for aligning the second part 703 with the first part 701.

FIG. 7C illustrates the third part 705. In an embodiment the third part 705 comprises a second lid portion 723 which comprises third indentations 725 which, when the third part 705 is coupled with the first part 701, will form the openings 103 with the first indentations 711. Additionally, the third part 705 further comprises a second hinge portion 727 which can receive the first hinge portion 707 from the second part 703 and a fourth connecting portions 729.

FIGS. 8A-8B illustrate the embodiment illustrated in FIGS. 7A-7C after the first part 701, the second part 703, and the third part 705 have been combined into the fiber bundle 100, with FIG. 8B illustrating a cross-sectional view of the structure of FIG. 8A. In this embodiment the first hinge portion 707 of the second part 703 is inserted into the second hinge portion 727 of the third part 705 to create a rotatable unit.

Once the second part 703 and the third part 705 have been joined together, the fiber bundle 100 may be placed around the optical fibers 201 (not separately illustrated in FIGS. 8A-8B), such that the individual optical fibers 201 are located within, e.g., the indentations of the first part 701. Once the individual optical fibers 201 are in place, the second part 703 and the third part 705 may be rotated into place to constrain the optical fibers 201 into place. For example, the second connecting portion 715 of the first part 701 may be inserted into the third part 705, and the second part 703 and the third part 705 are rotated to insert the third connecting portions 721 and the fourth connecting portions 729 into the first connecting portion 713 of the first part 701. However, any suitable method of placing the fiber bundle 100 around the optical fibers 201 may be used.

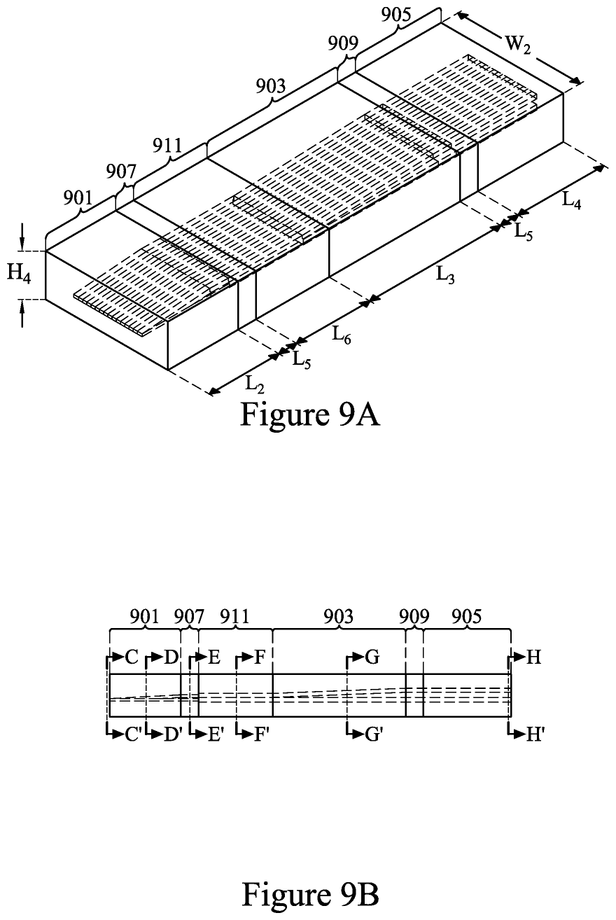

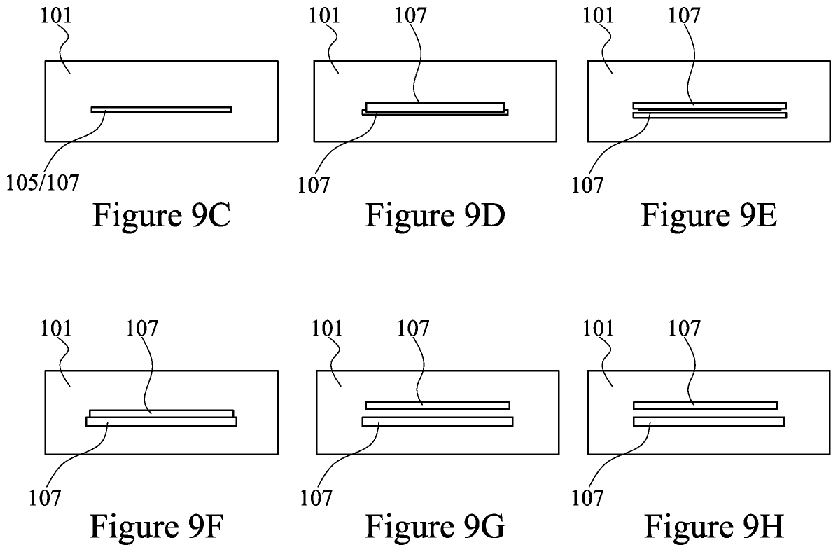

FIGS. 9A-9H illustrate yet another embodiment in which the fiber bundle 100 is a single unit, but in which the single unit has multiple zones in which horizontal and/or vertical shifts can be formed. Looking first at FIGS. 9A-9B, in which FIG. 9B is a cross sectional view of FIG. 9A, there is illustrated a fiber bundle 100 which comprises multiple directional shifts, such as a first vertical shift zone 901, a second vertical shift zone 903, and a first horizontal shift zone 905. In this embodiment the fiber bundle 100 may have a second width W₂ of between about 3 mm and about 10 mm, such as about 7 mm, and a fourth height H₄ of between about 1.5 mm and about 4 mm, such as about 2.4 mm. However, any suitable dimensions may be utilized.

Looking first at the first vertical shift zone 901, the first vertical shift zone 901 may have a second length L₂ of between about 3 mm and about 7 mm, such as about 4 mm. Additionally, within the first vertical shift zone 901, the first row 105 and the second row 107 may vertically shift from being spaced apart by about 140 μm to being within a single, horizontal row. However, any suitable dimensions may be utilized.

Looking next at the second vertical shift zone 903, the second vertical shift zone 903 may have a third length L₃ of between about 5.5 mm and about 10 mm, such as about 7.5 mm. Additionally, within the second vertical shift zone 903, the first row 105 and the second row 107 may vertically shift from being spaced apart by about 300 μm to being spaced apart by about 270 μm. However, any suitable dimensions may be utilized.

Looking at the first horizontal shift zone 905, the first horizontal shift zone 905 may have a fourth length L₄ of between about 4.5 mm and about 7 mm, such as about 4.95 mm. Additionally, within the first horizontal shift zone 905, the openings 103 within the first horizontal shift zone 905 may have the first row shifted 125 μm relative to the second row. However, any suitable shift in diameter may be utilized.

Additionally, in order to help allow for the shifts, the fiber bundle 100 in this embodiment may further comprise a first buffer zone 907 and a second buffer zone 909. The first buffer zone 907 and the second buffer zone 909 may be formed so that there are no horizontal or vertical shifts within the fiber bundle 100 within the first buffer zone 907 and the second buffer zone 909, and each of the first buffer zone 907 and the second buffer zone 909 may have a fifth length L₅ of between about 1 mm and about 3 mm, such as about 1 mm. However, any suitable dimensions may be utilized.

Finally, in some embodiments the fiber bundle 100 may comprise a lengthening zone 911. In an embodiment the lengthening zone 911 does not have any vertical or horizontal shifts and may simply extend the overall length of the fiber bundle 100 and may have a sixth length L₆ of between about 1 mm and about 5 mm, such as about 4.2 mm. However, any suitable length may be utilized.

Looking next at FIG. 9C-9H, each of these figures shows a cross-sectional view of the fiber bundle 100 in FIG. 9B at various locations. For example, FIG. 9C illustrates a cross-sectional view of the fiber bundle 100 at line C-C′ in FIG. 9B, while FIG. 9D illustrates a cross-sectional view of the fiber bundle 100 at line D-D′ in FIG. 9B, FIG. 9E illustrates a cross-sectional view of the fiber bundle 100 at line E-E′ in FIG. 9B, FIG. 9F illustrates a cross-sectional view of the fiber bundle 100 at line F-F′ in FIG. 9B, FIG. 9G illustrates a cross-sectional view of the fiber bundle 100 at line G-G′ in FIG. 9B, and FIG. 9H illustrates a cross-sectional view of the fiber bundle 100 at line H-H′ in FIG. 9B. As can be seen in these figures, the spacing between the first row 105 and the second row 107 will continue to get smaller along the length of the fiber bundle 100 until a single row is left.

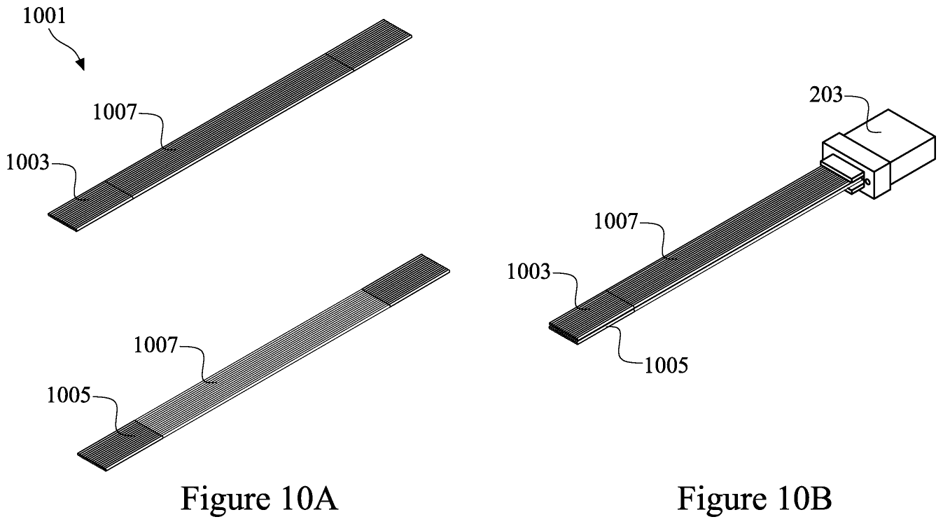

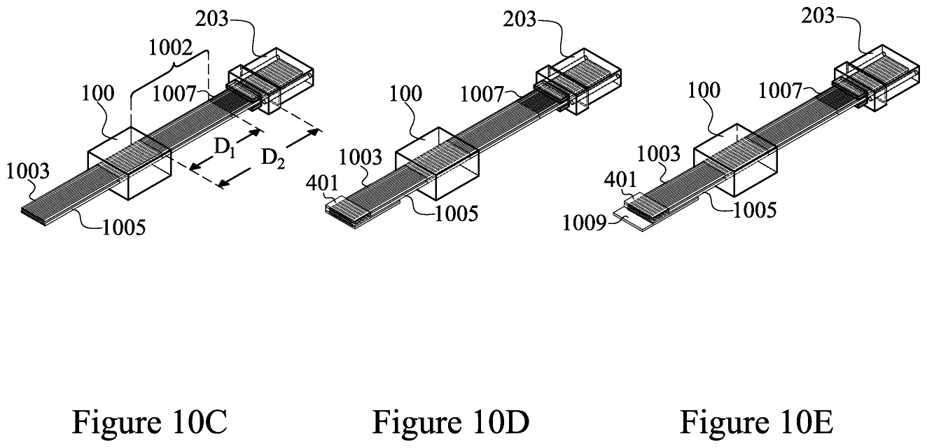

FIG. 10A illustrates an embodiment which uses ribbon fiber 1001 instead of individual optical fibers 201. In this embodiment the ribbon fiber 1001 comprises a first ribbon 1003 and a second ribbon 1005. In a particular example, the first ribbon 1003 and the second ribbon 1005 comprise internal optical fibers 201 (e.g., optical fibers 201 similar to those described above with respect to FIG. 2) surrounded by a ribbon coating 1007. The ribbon coating 1007 may be, for example, a coating with a thickness between about 10 μm and about 25 μm, such as about 15 μm. Additionally, the ribbon coating 1007 may have a length of between about 0 mm and about 40 mm, such as about 30 mm. However, any suitable dimensions may be utilized.

FIG. 10B illustrates an attachment of the ferrule 203 to the first ribbon 1003 and the second ribbon 1005. In an embodiment the attachment may be performed as described above with respect to FIG. 2, such as by inserting the first ribbon 1003 and the second ribbon 1005 into the ferrule 203 and then applying a glue to the first ribbon 1003 and the second ribbon 1005. However, any suitable attachment process, and any suitable ferrule 203, may be utilized.

FIG. 10C illustrates a removal of a portion of the outer coating of the first ribbon 1003 and the second ribbon 1005 and a placement of the internal optical fibers 201 of the first ribbon 1003 and the second ribbon 1005 through the fiber bundle 100. In an embodiment in which the first ribbon 1003 and the second ribbon 1005 are 37.7 mm long, 20.8 mm of the outer coating may be removed, and may be removed using a stripping process or the like. However, any suitable process may be utilized.

Additionally, once the outer coating has been removed, the now exposed portions of the optical fibers 201 may be inserted into the fiber bundle 100. In an embodiment the optical fibers 201 may be inserted as described above with respect to FIG. 3. However, any suitable process may be utilized.

In a particular embodiment the fiber bundle 100 may be placed in order to create a transition region 1002 between the fiber bundle 100 and the remainder of the ribbon coating 1007. For example, the fiber bundle 100 may be placed so that the transition region has a first distance D₁ of between about 5 mm and about 20 mm, such as about 13.3 mm. Such a location would cause the fiber bundle 100 to be located a second distance D₂ away from the ferrule 203, wherein the second distance D₂ is between about 5.5 mm and about 20.5 mm, such as about 18.3 mm. As such, the optical fiber 201 may have about 11.9 mm remaining on an opposite side of the fiber bundle 100 from the ferrule 203. However, any suitable dimensions may be utilized.

Optionally if desired, at this point in the process the optical fibers 201 may be adhered or glued to the fiber bundle 100. In an embodiment the optical fibers 201 may be adhered as described above with respect to FIG. 3. In other embodiments the optical fibers 201 may remain unadhered, such that the fiber bundle 100 is movable up and down the optical fibers 201.

FIG. 10D illustrates that, once the optical fibers 201 have been placed within the fiber bundle 100, the fiber array unit 401 may be placed on the optical fibers 201. In an embodiment the fiber array unit 401 may be placed as described above with respect to FIG. 4. However, any suitable methods and structures may be utilized.

FIG. 10E illustrates that, once the fiber array unit 401 has been placed around the optical fibers 201, an optional carrier unit 1009 may be attached to the fiber array unit 401 in order to provide control and support for the fiber array unit 401 as it is attached to other, external devices such as an optical engine (OE). In an embodiment the carrier unit 1009 may be a solid material such as silicon or glass which is adhered using a glue or other adhesive. However, any suitable structures and method of connection may be used.

By utilizing the fiber bundle 100, a better arrangement of the optical fibers 201 may be obtained, allowing for a greater packing density and obtaining greater support and relaxation. Additionally, easier automatic handling can be achieved with a smaller bending radius in all directions. Finally, the fiber bundle 100 is easily scalable to any number of optical fibers 201, so the fiber count is not limited.

In accordance with an embodiment, an optical device includes: a substrate material; and optical fiber openings extending from a first side of the substrate material to a second side of the substrate material, wherein the optical fiber openings at the first side of the substrate material are shifted either horizontally or vertically from the second side of the substrate material. In an embodiment the optical device further includes optical fibers extending through respective ones of the optical fiber openings. In an embodiment the substrate material is movable along the optical fibers. In an embodiment the optical device further includes an adhesive attaching the substrate material to the optical fibers. In an embodiment the optical device further includes a ferrule attached to the optical fibers. In an embodiment the optical device further includes a fiber array unit attached to the optical fibers on an opposite side of the substrate material from the ferrule. In an embodiment the optical fiber openings are aligned in a single row at the second side of the substrate material.

In accordance with another embodiment, an optical device includes: a plurality of optical fibers extending between a ferrule and a fiber array unit; and a fiber bundle surrounding the plurality of optical fibers between the ferrule and the fiber array unit. In an embodiment the fiber bundle includes a first portion, a second portion separable from the first portion, and a third portion separable from the first portion and the second portion. In an embodiment the fiber bundle further includes: a first dispensing region; and a second dispensing region. In an embodiment the plurality of the optical fibers have a horizontal shift as the optical fibers extend through the fiber bundle. In an embodiment the plurality of the optical fibers have a vertical shift as the optical fibers extend through the fiber bundle. In an embodiment the plurality of the optical fibers have a horizontal shift and a vertical shift as the optical fibers extend through the fiber bundle. In an embodiment the fiber bundle includes: a first vertical shift zone; a second vertical shift zone; a first horizontal shift zone; and buffer regions separating the first vertical shift zone, the second vertical shift zone, and the first horizontal shift zone.

In accordance with yet another embodiment, a method of manufacturing an optical device includes: receiving a fiber bundle, the fiber bundle including: a substrate material; and a plurality of optical fiber openings extending through the substrate material, wherein the plurality of optical fiber openings at a first side of the substrate material are shifted either horizontally or vertically from a second side of the substrate material; and constraining a plurality of optical fibers with the fiber bundle. In an embodiment the constraining the plurality of the optical fibers comprises rotating a first portion of the fiber bundle towards a second portion of the fiber bundle. In an embodiment the constraining the optical fibers comprises threading the plurality of optical fibers through the plurality of optical fiber openings. In an embodiment the threading the plurality of optical fibers threads the optical fibers through a first vertical shift zone, a second vertical shift zone, and a first horizontal shift zone, wherein buffer regions separate the first vertical shift zone, the second vertical shift zone, and the first horizontal shift zone. In an embodiment the method further includes removing an outer coating of a ribbon from the plurality of optical fibers prior to the constraining the plurality of optical fibers. In an embodiment the method further includes constraining a dummy fiber with the fiber bundle.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical device comprising:
a substrate material; and
optical fiber openings extending from a first side of the substrate material to a second side of the substrate material, wherein the optical fiber openings at the first side of the substrate material are shifted either horizontally or vertically from the second side of the substrate material.

2. The optical device of claim 1, further comprising optical fibers extending through respective ones of the optical fiber openings.

3. The optical device of claim 2, wherein the substrate material is movable along the optical fibers.

4. The optical device of claim 2, further comprising an adhesive attaching the substrate material to the optical fibers.

5. The optical device of claim 2, further comprising a ferrule attached to the optical fibers.

6. The optical device of claim 5, further comprising a fiber array unit attached to the optical fibers on an opposite side of the substrate material from the ferrule.

7. The optical device of claim 1, wherein the optical fiber openings are aligned in a single row at the second side of the substrate material.

8. An optical device comprising:
a plurality of optical fibers extending between a ferrule and a fiber array unit; and
a fiber bundle surrounding the plurality of optical fibers between the ferrule and the fiber array unit.

9. The optical device of claim 8, wherein the fiber bundle comprises a first portion, a second portion separable from the first portion, and a third portion separable from the first portion and the second portion.

10. The optical device of claim 8, wherein the fiber bundle further comprises:
a first dispensing region; and
a second dispensing region.

11. The optical device of claim 8, wherein the plurality of the optical fibers have a horizontal shift as the optical fibers extend through the fiber bundle.

12. The optical device of claim 8, wherein the plurality of the optical fibers have a vertical shift as the optical fibers extend through the fiber bundle.

13. The optical device of claim 8, wherein the plurality of the optical fibers have a horizontal shift and a vertical shift as the optical fibers extend through the fiber bundle.

14. The optical device of claim 8, wherein the fiber bundle comprises:
a first vertical shift zone;
a second vertical shift zone;
a first horizontal shift zone; and
buffer regions separating the first vertical shift zone, the second vertical shift zone, and the first horizontal shift zone.

15. A method of manufacturing an optical device, the method comprising:
receiving a fiber bundle, the fiber bundle comprising:
a substrate material; and
a plurality of optical fiber openings extending through the substrate material, wherein the plurality of optical fiber openings at a first side of the substrate material are shifted either horizontally or vertically from a second side of the substrate material; and
constraining a plurality of optical fibers with the fiber bundle.

16. The method of claim 15, wherein the constraining the plurality of the optical fibers comprises rotating a first portion of the fiber bundle towards a second portion of the fiber bundle.

17. The method of claim 15, wherein the constraining the optical fibers comprises threading the plurality of optical fibers through the plurality of optical fiber openings.

18. The method of claim 17, wherein the threading the plurality of optical fibers threads the optical fibers through a first vertical shift zone, a second vertical shift zone, and a first horizontal shift zone, wherein buffer regions separate the first vertical shift zone, the second vertical shift zone, and the first horizontal shift zone.

19. The method of claim 15, further comprising removing an outer coating of a ribbon from the plurality of optical fibers prior to the constraining the plurality of optical fibers.

20. The method of claim 15, further comprising constraining a dummy fiber with the fiber bundle.
